(19) United States
(12) Patent Application Publication
(10) Pub. No.: US 2004/0207380 A1
(43) Pub. Date: Oct. 21, 2004

(54) Reference voltage generating circuit capable of controlling temperature dependency of reference voltage

(75) Inventor: Takuya Ariki, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/658,192

(22) Filed: Sep. 10, 2003

(30) Foreign Application Priority Data
Apr. 11, 2003 (JP) 2003-107758(P)

(51) Int. Cl. G05F 3/16

(52) U.S. Cl. 323/313

(57) ABSTRACT

A constant current which is output from a constant current circuit having a positive temperature characteristic and a constant current which is output from a constant current circuit having a negative temperature characteristic are both input to a current synthesizing circuit. The current synthesizing circuit synthesizes the constant currents at a ratio which allows a temperature characteristic to be within a range between the positive temperature characteristic and the negative temperature characteristic and accordingly outputs a constant current having an arbitrary temperature dependency within a specific range. The constant current output from the current synthesizing circuit is input to a current-voltage converting circuit to be converted into a reference voltage.

### BACKGROUND OF THE INVENTION

1. Field of the Invention

The present invention relates to a reference voltage generating circuit and particularly to a reference voltage generating circuit for use in a semiconductor integrated circuit.

2. Description of the Background Art

Generally, for such a semiconductor integrated circuit as DRAM (Dynamic Random-Access Memory), a reference voltage is first generated from an externally supplied power-supply voltage and then several types of internal power-supply voltages are generated from the reference voltage. Therefore, the accuracy of the internal power-supply voltages depend on the accuracy of the reference voltage.

Reduction in voltage is one of technical trends in the field of the semiconductor integrated circuit. As the voltage of the semiconductor integrated circuit is decreased, a variation in reference voltage, which has caused no particular problem, becomes a noticeable issue to be addressed.

A conventional reference voltage generating circuit disclosed in Japanese Patent Laying-Open No. 2000-11649, pages 11-13 (FIGS. 2 and 3) includes a first voltage generating circuit generating a first voltage having a positive temperature characteristic and a second voltage generating circuit generating a second voltage having a negative or zero temperature characteristic, and an OR circuit selecting a higher one of the first and second voltages to output the selected one as a reference voltage.

The conventional reference voltage generating circuit disclosed in Japanese Patent Laying-Open No. 2000-11649, pages 11-13 (FIGS. 2 and 3) can generate a reference voltage which has the negative or zero temperature characteristic in a low-temperature region and has the positive temperature characteristic in a high-temperature region. However, a problem of the circuit is that the temperature characteristics relative to the temperature regions are limited to such characteristics as described above.

### SUMMARY OF THE INVENTION

An object of the present invention is to provide a reference voltage generating circuit capable of setting a temperature dependency of a reference voltage within a range between a predetermined positive temperature characteristic and a predetermined negative temperature characteristic.

According to the present invention, a reference voltage generating circuit includes a first constant current circuit having a positive temperature characteristic and outputting a first constant current, a second constant current circuit having a negative temperature characteristic and outputting a second constant current, a current synthesizing circuit synthesizing the first constant current and the second constant current to generate a third constant current, the first and second constant currents being synthesized at a ratio which allows a temperature characteristic of the third constant current to be within a range between the positive temperature characteristic and the negative temperature characteristic, and a current-voltage converting circuit converting the third constant current into a voltage to generate a reference voltage.

According to the present invention, the temperature dependency of the reference voltage can be set within a range between a predetermined positive temperature characteristic and a predetermined negative temperature characteristic.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic configuration of a reference voltage generating circuit 10 according to a first embodiment of the present invention.

FIG. 2 is a circuit diagram showing a circuit configuration of a constant current circuit 1A according to the first embodiment of the present invention.

FIG. 3 is a circuit diagram showing a circuit configuration of a constant current circuit 2A according to the first embodiment of the present invention.

FIG. 4 is a circuit diagram showing a circuit configuration of a current synthesizing circuit 3A according to the first embodiment of the present invention.

FIG. 5 shows temperature characteristics of currents I1 and I2 as well as current I.

FIG. 6 is a circuit diagram showing a circuit configuration of an N-channel MOS transistor unit 33A having its channel width which can be changed.

FIG. 7 is a circuit diagram showing a circuit configuration of an N-channel MOS transistor unit 33B having its channel which can be changed.

FIG. 8 is a circuit diagram showing a circuit configuration of a current-voltage converting circuit 4A according to the first embodiment of the present invention.

FIG. 9 is a circuit diagram showing a circuit configuration of a current-voltage converting circuit 4B according to a second embodiment of the present invention.

FIG. 10 shows a relation between a drain current Id and a gate-to-source voltage Vgs of a general N-channel MOS transistor.

FIG. 11 shows a relation between a reference voltage VREFb and a resistance value Rb of the current-voltage converting circuit 4B.

FIG. 12 is a circuit diagram showing a circuit configuration of a current-voltage converting circuit 4C according to the second embodiment of the present invention.

FIG. 13 shows a relation between a reference voltage VREFc and a resistance value Rc of the current-voltage converting circuit 4C.

FIG. 14 is a circuit diagram showing a circuit configuration of a current-voltage converting circuit 4D according to the second embodiment of the present invention.

FIG. 15 shows a relation between a reference voltage VREFd and a resistance value Rd of the current-voltage converting circuit 4D.

### DESCRIPTION OF THE PREFERRED EMBODIMENTS

Embodiments of the present invention are now described in detail with reference to the drawings. It is noted that the same or like components in the drawings are denoted by the same reference character and description thereof is not repeated here.

First Embodiment

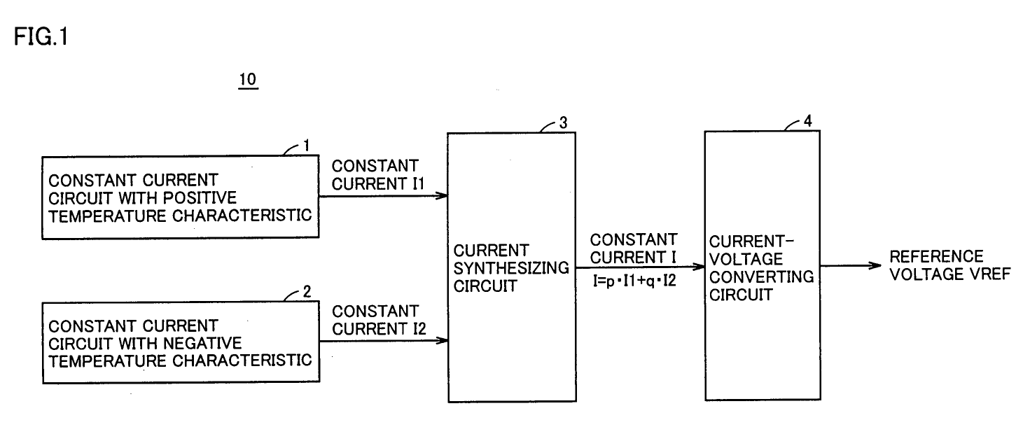

FIG. 1 is a block diagram showing a schematic configuration of a reference voltage generating circuit 10 according to a first embodiment of the present invention.

As shown in FIG. 1, reference voltage generating circuit 10 of the first embodiment includes a constant current circuit 1 having a positive temperature characteristic, a constant current circuit 2 having a negative temperature characteristic, a current synthesizing circuit 3, and a current-voltage converting circuit 4. Here, “a circuit having a positive temperature characteristic” means that a current generated by the circuit increases as the temperature increases, and “a circuit having a negative temperature characteristic” means that a current generated by the circuit decreases as the temperature increases.

A constant current I1 which is output from constant current circuit 1 having the positive temperature characteristic and a constant current I2 which is output from constant current circuit 2 having the negative temperature characteristic are both input to current synthesizing circuit 3. Current synthesizing circuit 3 synthesizes constant currents I1 and I2 at a ratio which allows a resultant temperature characteristic to be within a range between the positive temperature characteristic of constant current I1 and the negative temperature characteristic of constant current I2. In this way, current synthesizing circuit 3 outputs a constant current I=p·I1+q·I2 (p and q are factors including zero). Constant current I is input to current-voltage converting circuit 4 to be converted into a reference voltage VREF.

As discussed above, the constant current having the positive temperature characteristic and the constant current having the negative temperature characteristic are synthesized at a ratio which allows a resultant temperature characteristic to be within a range between the positive temperature characteristic and the negative temperature characteristic, the resultant constant current is then converted into a voltage, and thus the temperature dependency of the reference voltage can arbitrarily be set within a specific range.

Specific configurations of respective circuits constituting reference voltage generating circuit 10 are detailed below.

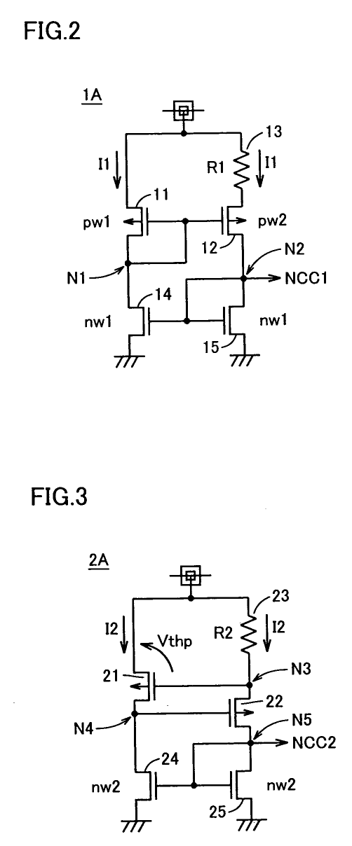

FIG. 2 is a circuit diagram showing a circuit configuration of a constant current circuit 1A according to the first embodiment of the present invention.

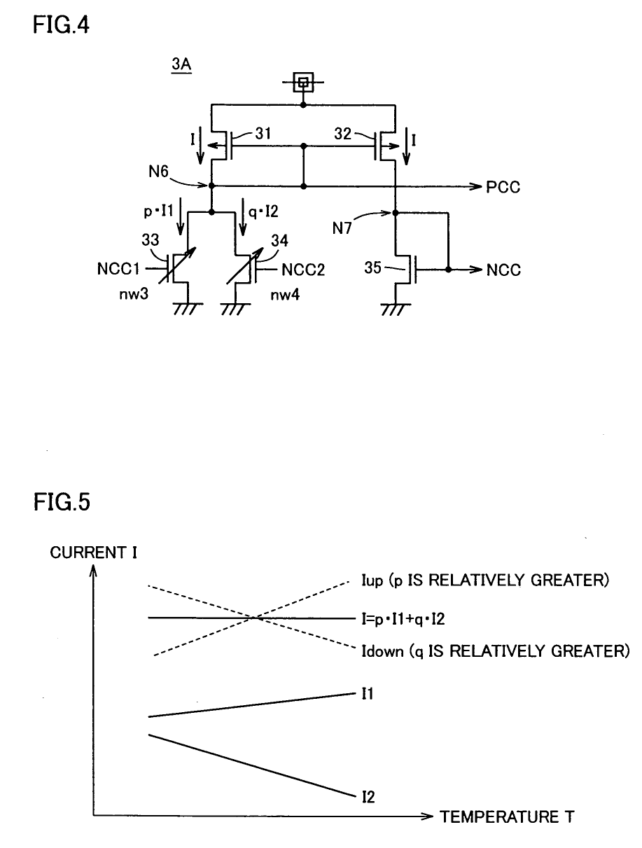

Constant current circuit 1A of the first embodiment shown in FIG. 2 includes a P-channel MOS transistor 11 connected between a power supply node and a node N1 and having its gate connected to node N1, a P-channel MOS transistor 12 connected between the power supply node and a node N2 and having its gate connected to node N1, a resistance element 13 connected between the power supply node and P-channel MOS transistor 12 and having a resistance value R1, an N-channel MOS transistor 14 connected between node N1 and a ground node and having its gate connected to node N2, and an N-channel MOS transistor 15 connected between node N2 and the ground node and having its gate connected to node N2. A signal NCC1 drawn from node N2 is hereinlater described in conjunction with FIG. 4.

N-channel MOS transistors 14 and 15 constitute a current mirror circuit and have the same size (“size” means a ratio between the channel width and the channel length). Accordingly, current I1 of the same magnitude flows through each of P-channel MOS transistors I1 and I2. N-channel MOS transistors 14 and 15 have the same channel width which is herein indicated by nw1.

On the other hand, P-channel MOS transistors 11 and 12 have the same channel length while respective channel widths pw1 and pw2 are different from each other that have a relation pw1<pw2. Resistance element 13 has a sufficiently large resistance value R1, and thus current I1 is a minute current and P-channel MOS transistors 11 and 12 operate in a sub threshold region. In this case, current I1 is represented by the following formula:

I1=S/R1·log (pw2/pw1)

where S is one of physical parameters of the MOS transistor that is called sub-threshold factor, tailing factor, S factor or the like. Here, S is referred to as S factor. The S factor has a relation, S∝kT/q (k: Boltzmann constant, T: absolute temperature, q: elementary quantity of electric charge), and has a positive temperature characteristic. Resistance element 13 is a resistance element which is made of polysilicon or the like and has a small temperature coefficient compared with that of S factor.

Therefore, the temperature characteristic of current I1 substantially directly reflects the temperature characteristic of S factor and is the positive temperature characteristic accordingly. Such a constant current circuit as constant current circuit 1A setting operating points of P-channel MOS transistors 11 and 12 in a sub-threshold region to produce a constant current is referred to as weak-inversion type.

FIG. 3 is a circuit diagram showing a circuit configuration of a constant current circuit 2A according to the first embodiment of the present invention.

Constant current circuit 2A of the first embodiment shown in FIG. 3 includes a P-channel MOS transistor 21 connected between the power supply node and a node N4 and having its gate connected to a node N3, a P-channel MOS transistor 22 connected between node N3 and a node N5 and having its gate connected to node N4, a resistance element 23 connected between the power supply node and P-channel MOS transistor 22 and having a resistance value R2, an N-channel MOS transistor 24 connected between node N4 and the ground node and having its gate connected to node N5, and an N-channel MOS transistor 25 connected between node N5 and the ground node and having its gate connected to node N5. A signal NCC2 drawn from node N5 is hereinlater described in conjunction with FIG. 4.

N-channel MOS transistors 24 and 25 form a current mirror circuit and have the same size. A current I2 of the same magnitude thus flows through each of P-channel MOS transistors 21 and 22. N-channel MOS transistors 24 and 25 have the same channel width which is herein indicated by nw2.

On the other hand, the size of P-channel MOS transistor 21 and resistance value R2 of resistance element 23 are set to allow a gate-to-source voltage of P-channel MOS transistor 21 to be or close to a threshold voltage Vthp. Here, current 12 is represented by the following formula:

I2=Vthp/R2.

The threshold voltage of the MOS transistor usually has a negative temperature coefficient of approximately −2 mV/° C. Resistance element 23 has a small temperature coefficient compared with the negative temperature coefficient.

Therefore, the temperature characteristic of current I2 substantially directly reflects the temperature characteristic of the threshold voltage of the MOS transistor and has a negative temperature characteristic. Such a constant current circuit as constant current circuit 2A which generates a constant current by setting the operating point of P-channel MOS transistor 21 to be or close to the threshold is called threshold type.

A current synthesizing circuit 3A is now described that synthesizes constant current I1 generated by constant current circuit 1A and having a positive temperature characteristic with constant current I2 generated by constant current circuit 2A and having a negative temperature characteristic, at a ratio which allows a resultant temperature characteristic to be within a range between the positive temperature characteristic of constant current I1 and the negative temperature characteristic of constant current I2, thereby generating constant current I having a temperature dependency within a specific range.

FIG. 4 is a circuit diagram showing a circuit configuration of current synthesizing circuit 3A according the first embodiment of the present invention.

Current synthesizing circuit 3A of the first embodiment that is shown in FIG. 4 includes a P-channel MOS transistor 31 connected between the power supply node and a node N6 and having its gate connected to node N6, a P-channel MOS transistor 32 connected between the power supply node and a node N7 and having its gate connected to node N6, an N-channel MOS transistor 33 connected between node N6 and the ground node and having its gate receiving signal NCC1 drawn from node N2 in FIG. 2, an N-channel MOS transistor 34 connected between node N6 and the ground node and having its gate receiving signal NCC2 drawn from node N5 in FIG. 3, and an N-channel MOS transistor 35 connected between node N7 and the ground node and having its gate connected to node N7. Respective channel widths nw3 and nw4 of N-channel MOS transistors 33 and 34 may be changed according to conditions.

N-channel MOS transistor 33 and N-channel MOS transistors 14 and 15 shown in FIG. 2 constitute a current mirror circuit and have the same channel length. Regarding the channel width, the channel width of N-channel MOS transistor 33 is nw3 and that of N-channel MOS transistors 14 and 15 is nw1. Then, a current, (nw3/nw1) I1, flows through N-channel MOS transistor 33.

Further, N-channel MOS transistor 34 and N-channel MOS transistors 24 and 25 shown in FIG. 3 constitute a current mirror circuit and have the same channel length. As for the channel width, the channel width of N-channel MOS transistor 34 is nw4 and that of N-channel MOS transistors 24 and 25 is nw2. Then, a current, (nw4/nw2) I2, flows through N-channel MOS transistor 34.

Accordingly, current I flowing through P-channel MOS transistor 31 is represented by:

I=p·I1+q·I2

where p=nw3/nw1 and q=nw4/nw2.

P-channel MOS transistors 31 and 32 constitute a current mirror circuit and thus current I also flows through P-channel MOS transistor 32. This current I can be obtained by means of a current mirror circuit, for example. The current mirror circuit may be configured by using, as a common gate signal, a signal PCC drawn from node N6 or a signal NCC drawn from node N7.

FIG. 5 shows temperature characteristics of currents I1 and I2 as well as current I.

As shown in FIG. 5, current 11 has a positive temperature characteristic while current I2 has a negative temperature characteristic. Currents I1 and 12 are multiplied respectively by factors p and q and then synthesized to produce current I=p I1+q·I2. Factors p and q are adjustable by changing channel widths nw3 and nw4 of N-channel MOS transistors 33 and 34 in FIG. 4.

Current I indicated by the solid line in FIG. 5 is produced by adjusting factors p and q so that current I has no temperature dependency. This current I without temperature dependency is merely an example. Current I may be a current Iup indicated by the dotted line in FIG. 5 produced by setting factor p relatively greater than factor q so that current Iup has a positive temperature characteristic or may be a current Idown indicated by the dotted line in FIG. 5 produced by setting factor q relatively greater than factor p so that current Idown has a negative current characteristic.

Moreover, current I1 or I2 may directly be current I. This is accomplished by inhibiting one of N-channel MOS transistors 33 and 34 in FIG. 4 from operating (one of factors p and q is set to zero).

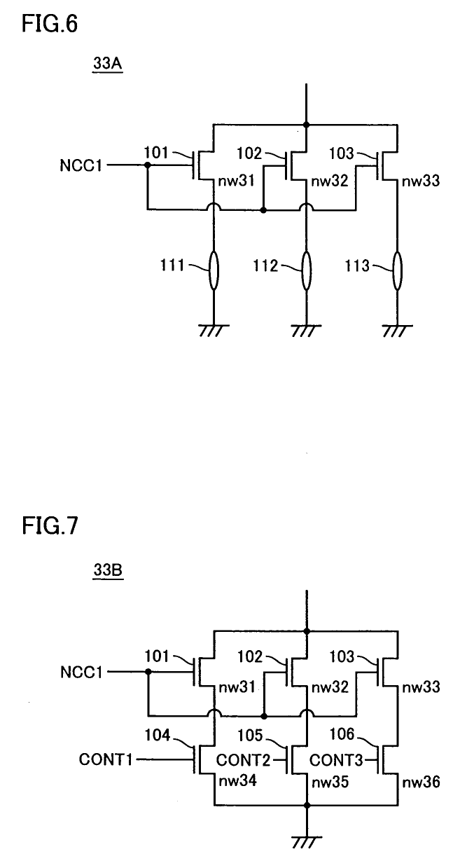

As discussed above, respective channel widths nw3 and nw4 of N-channel MOS transistors 33 and 34 shown in FIG. 4 can be changed to establish a certain ratio between factors p and q and thus arbitrarily set the temperature dependency of constant current I within a specific range. Particular means for changing channel widths nw3 and nw4 of N-channel MOS transistors 33 and 34 are described below in conjunction with FIGS. 6 and 7. In the following example described now, the channel width of N-channel MOS transistor 33 is changed.

FIG. 6 is a circuit diagram showing a circuit configuration of an N-channel MOS transistor unit 33A having its channel width which can be changed.

As shown in FIG. 6, N-channel MOS transistor unit 33A includes N-channel MOS transistors 101-103 and fuses 111-113. N-channel MOS transistors 101-103 have respective drains that are commonly connected, respective sources connected to one-ends of fuses 111-113, and respective gates receiving signal NCC1 drawn from node N2 in FIG. 2. The other ends of fuses 111-113 are connected to the ground node.

N-channel MOS transistors 101-103 have the same channel length and respective channel widths of nw31, nw32 and nw33. In N-channel MOS transistor unit 33A shown in FIG. 6, fuses 111-113 can arbitrarily be blown to adjust the channel width of N-channel MOS transistor unit 33A.

FIG. 7 is a circuit diagram showing a circuit configuration of an N-channel MOS transistor unit 33B having its channel width which can be adjusted.

As shown in FIG. 7, N-channel MOS transistor unit 33B includes N-channel MOS transistors 101-106. N-channel MOS transistors 101-103 have respective drains that are commonly connected, respective sources connected to respective drains of N-channel MOS transistors 104-106 and respective gates receiving signal NCC1 drawn from node N2 in FIG. 2. N-channel MOS transistors 104-106 have respective sources connected to the ground node and respective gates receiving control signals CONT1, CONT2 and CONT3 respectively.

N-channel MOS transistors 104-106 have the same channel length. Channel widths of N-channel MOS transistors 104, 105 and 106 are respectively nw34, nw35 and nw36. In N-channel MOS transistor unit 33B shown in FIG. 7, control signals CONT1, CONT2 and CONT3 are controlled so as to arbitrarily turn on/off N-channel MOS transistors 104-106 and thereby adjust the channel width of N-channel MOS transistor unit 33B.

Respective channel widths nw31, nw32 and nw33 of N-channel MOS transistors 101, 102 and 103 may be set to be the same, or to have a ratio of 1:2:4 therebetween, for example. By setting a specific ratio between channel widths nw31, nw32 and nw33, the channel width of N-channel MOS transistor units 33A and 33B can be adjusted within a wide range.

Further, N-channel MOS transistor units 33A and 33B may be combined to produce a circuit configuration. In this case, for example, an appropriate channel width may be determined by adjusting control signals CONT1, CONT2 and CONT3 in test to subsequently blow fuses.

A current-voltage converting circuit 4A converting constant current I generated by current synthesizing circuit 3A into a reference voltage VREFa is now described.

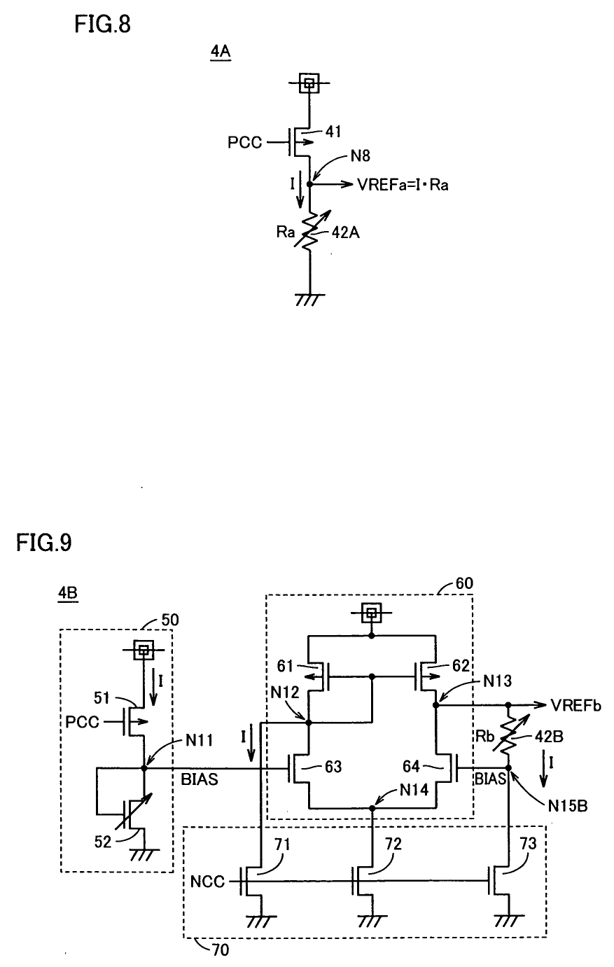

FIG. 8 is a circuit diagram showing a circuit configuration of current-voltage converting circuit 4A according to the first embodiment of the present invention.

Current-voltage converting circuit 4A of the first embodiment that is shown in FIG. 8 includes a P-channel MOS transistor 41 connected between the power supply node and a node N8 and having its gate receiving signal PCC drawn from node N6 in FIG. 4, and a variable-resistance element 42A connected between node N8 and the ground node. Suppose that variable-resistance element 42A has a resistance value Ra.

P-channel MOS transistor 41 and P-channel MOS transistors 31 and 32 in FIG. 4 constitute a current mirror circuit. Through P-channel MOS transistor 41, current I independent of a power supply voltage VCC flows. According to Ohm's law, a reference voltage VREFa=I·Ra is thus obtained from node N8.

As mentioned above, the temperature dependency of current I may arbitrarily be set by changing channel widths nw3 and nw4 of N-channel MOS transistors 33 and 34 shown in FIG. 4. Further, variable resistance element 42A has a small temperature coefficient compared with the positive and negative temperature coefficient described in FIGS. 2 and 3.

Then, the temperature dependency of reference voltage VREFa obtained from node N8 can arbitrarily be set by changing channel widths nw3 and nw4 of N-channel MOS transistors 33 and 34 shown in FIG. 4. Further, reference voltage VREFa can be adjusted to a desired voltage value by trimming resistance value Ra of variable-resistance element 42A.

As heretofore discussed, according to the first embodiment, a constant current having a positive temperature characteristic and a constant current having a negative temperature characteristic are synthesized at a ratio which allows a resultant temperature characteristic to be within a range between the positive temperature characteristic and the negative temperature characteristic, and the resultant constant current is converted into a voltage. In this way, the temperature dependency of the reference voltage can arbitrarily be set within a specific range.

Second Embodiment

If reference voltage generating circuit 10 of the first embodiment tries to reduce a value of current I in order to decrease a standby current while it produces the same reference voltage VREFa, resistance value Ra of variable-resistance element 42A of current-voltage converting circuit 4A has to be increased accordingly.

However, since variable-resistance element 42A is made of such a material as polysilicon, the increase of resistance value Ra of variable-resistance element 42A has a direct influence on the layout area of a chip including variable resistance element 42A. Then, a problem of the circuit configuration of current-voltage converting circuit 4A of the first embodiment is that, there is a trade-off relation between the reduction of current I and reduction of the layout area of the chip including variable-resistance element 42A.

Accordingly, a current-voltage converting circuit 4B is provided according to a second embodiment, requiring no increase in layout area of a chip including a variable-resistance element even if the value of current I is reduced.

FIG. 9 is a circuit diagram showing a circuit configuration of current-voltage converting circuit 4B according to the second embodiment of the present invention.

Current-voltage converting circuit 4B of the second embodiment shown in FIG. 9 includes a bias voltage generating unit 50, a voltage follower unit 60, a current balance unit 70 and a variable-resistance element 42B.

Bias voltage generating unit 50 includes a P-channel MOS transistor 51 connected between the power supply node and a node N11 and having its gate receiving signal PCC drawn from node N6 in FIG. 4, and an N-channel MOS transistor 52 connected between node N11 and the ground node and having its gate connected to node N1. The size of N-channel MOS transistor 52 may be changed according to conditions.

P-channel MOS transistor 51 and P-channel MOS transistors 31 and 32 in FIG. 4 constitute a current mirror circuit. Through P-channel MOS transistor 51, current I independent of power supply voltage VCC flows. Further, N-channel MOS transistor 52 is diode-connected and a gate-to-source voltage of N-channel MOS transistor 52 appears, as a bias voltage BIAS, on node N11. Here, a temperature dependency of the gate-to-source voltage of a general N-channel MOS transistor is described.

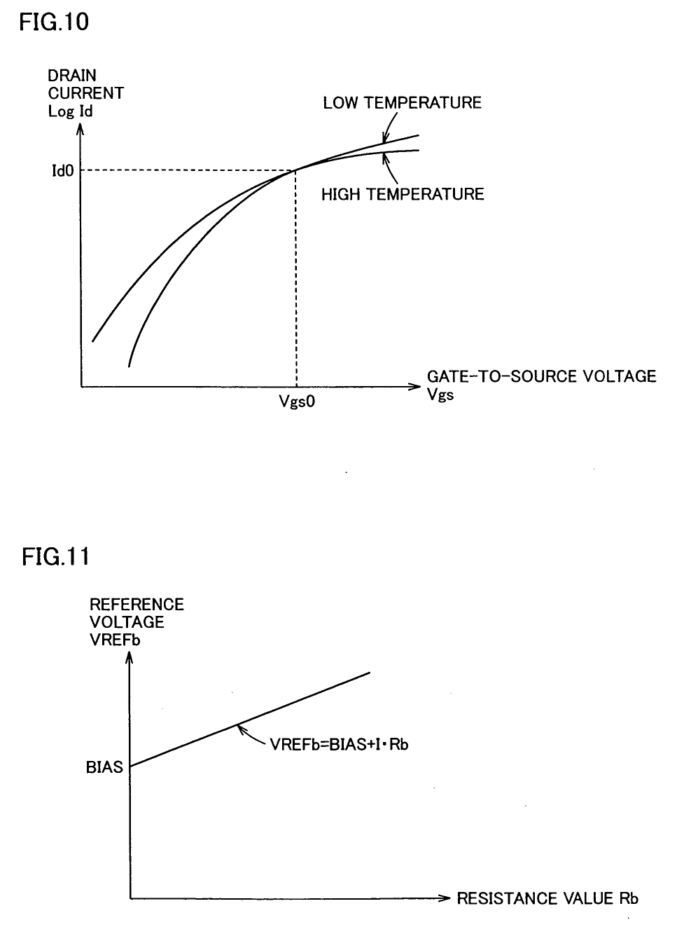

FIG. 10 shows a relation between a drain current Id and a gate-to-source voltage Vgs of a general N-channel MOS transistor. It is noted that drain Id on the vertical axis is expressed in a logarithmic scale.

As shown in FIG. 10, the relation between drain current Id and gate-to-source voltage Vgs of the general N-channel MOS transistor usually has a temperature dependency. The temperature dependency disappears, however, when drain current Id is Id0 and accordingly gate-to-source voltage Vgs is Vgs0 regardless of whether the temperature is high or low.

Gate-to-source voltage Vgs of the N-channel MOS transistor can be adjusted by changing the size of the N-channel MOS transistor. Referring to FIG. 9 again, bias voltage BIAS having no temperature dependency can be produced by adjusting the gate-to-source voltage of N-channel MOS transistor 52 to Vgs0 with which the temperature dependency disappears.

Voltage-follower unit 60 includes a P-channel MOS transistor 61 connected between the power supply node and a node N12 and having its gate connected to node N12, a P-channel MOS transistor 62 connected between the power supply node and a node N13 and having its gate connected to node N12, an N-channel MOS transistor 63 connected between node N12 and a node N14 and having its gate receiving bias voltage BIAS from node N11, and an N-channel MOS transistor 64 connected between node N13 and node N14 and having its gate connected to a node N15B.

Voltage-follower unit 60 receives bias voltage BIAS with a high input impedance and outputs bias voltage BIAS of the same value to node N15B with a low output impedance.

Current balance unit 70 includes an N-channel MOS transistor 71 connected between node N12 and the ground node and having its gate receiving signal NCC drawn from node N7 in FIG. 4, an N-channel MOS transistor 72 connected between node N14 and the ground node and having its gate receiving signal NCC drawn from node N7 in FIG. 4 and an N-channel MOS transistor 73 connected between node N15B and the ground node and having its gate receiving signal NCC drawn from node N7 in FIG. 4.

In current balance unit 70, N-channel MOS transistors 71, 72 and 73 constitute a current mirror circuit to maintain a balance between currents respectively flowing from nodes N12, N13 and N14 of voltage follower unit 60.

Variable-resistance element 42B is connected between node N13 and node N15B. It is assumed here that the resistance value of variable-resistance element 42B is Rb. Bias voltage BIAS is supplied to node N15B and constant current I flows through variable-resistance element 42B. Then, reference voltage VREFb of current-voltage converting circuit 4B that is supplied from node N13 is represented by:

VREFb=BIAS+I·Rb.

Bias voltage BIAS has no temperature dependency and variable-resistance element 42B having resistance value Rb has a small temperature coefficient compared with the positive and negative temperature coefficient described in FIGS. 2 and 3. Therefore, reference voltage VREFb of current-voltage converting circuit 4B has its temperature dependency which is substantially the same as that of constant current I.

FIG. 11 shows a relation between reference voltage VREFb and resistance value Rb of current-voltage converting circuit 4B.

As shown in FIG. 11, reference voltage VREFb of current-voltage converting circuit 4B increases in proportion to the increase of resistance value Rb of variable-resistance element 42B.

Further, reference voltage VREFb is higher than reference voltage VREFa of current-voltage converting circuit 4A of the first embodiment by the magnitude of bias voltage BIAS. Accordingly, even if the value of current I is decreased, it is still possible to keep an increase of resistance value Rb within a certain limit and thus avoid an increase of the layout area of the chip including variable-resistance element 42B.

A current-voltage converting circuit 4C is now described that differs from current-voltage converting circuit 4B in terms of the connection of the variable-resistance element and the node from which the reference voltage is supplied.

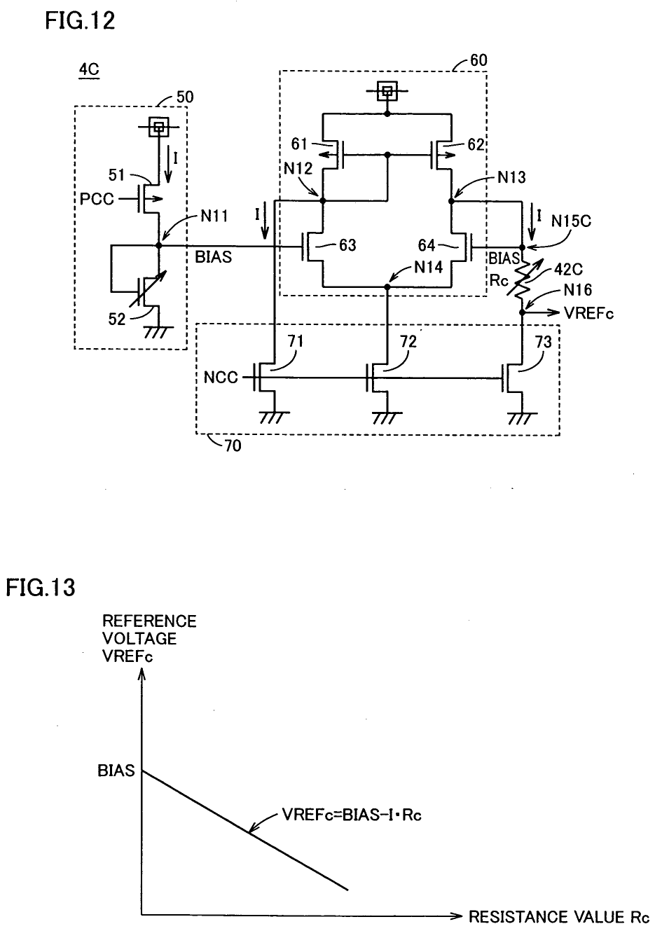

FIG. 12 is a circuit diagram showing a circuit configuration of current-voltage converting circuit 4C according to the second embodiment of the present invention.

Current-voltage converting circuit 4C of the second embodiment that is shown in FIG. 12 includes a bias voltage generating unit 50, a voltage follower unit 60, a current balance unit 70, and a variable-resistance element 42C.

As bias voltage generating unit 50, voltage follower unit 60 and current balance unit 70 are equivalent to those of current-voltage converting circuit 4B shown in FIG. 9, description thereof is not repeated here.

Variable-resistance element 42C is connected between a node N15C and a node N16. It is assumed here that the resistance value of variable-resistance element 42C is Rc. Bias voltage BIAS is supplied to node N15C and constant current I flows through variable-resistance element 42C. Then, reference voltage VREFc of current-voltage converting circuit 4C that is supplied from node N16 is represented by:

VREFc=BIAS−I·Rc.

Bias voltage BIAS has no temperature dependency and variable-resistance element 42C having resistance value Rc has a small temperature coefficient compared with the positive and negative temperature coefficient described in FIGS. 2 and 3. Therefore, reference voltage VREFc of current-voltage converting circuit 4C has its temperature dependency which is substantially the same as that of constant current I.

FIG. 13 shows a relation between reference voltage VREFc and resistance value Rc of current-voltage converting circuit 4C.

As shown in FIG. 13, reference voltage VREFc of current-voltage converting circuit 4C decreases in proportion to the increase of resistance value Rc of variable-resistance element 42C.

A current-voltage converting circuit 4D is described below that is a combination of current-voltage converting circuits 4B and 4C.

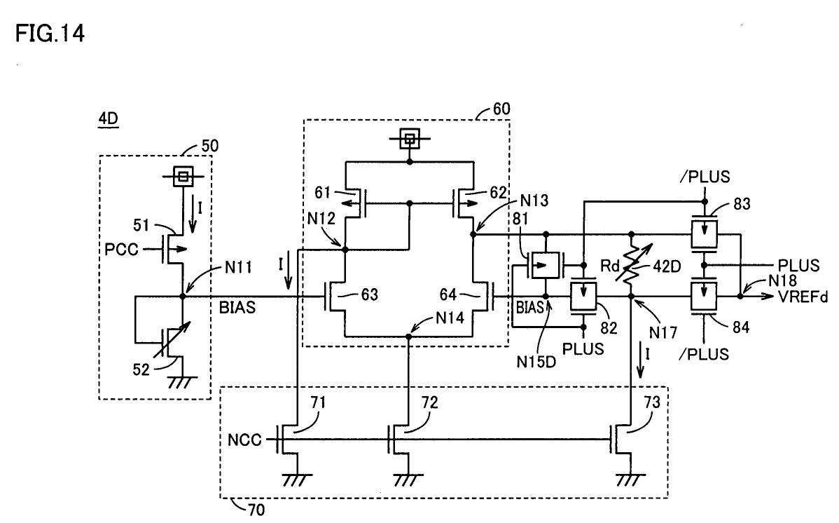

FIG. 14 is a circuit diagram showing a circuit configuration of current-voltage converting circuit 4D according to the second embodiment of the present invention.

Current-voltage converting circuit 4D of the second embodiment that is shown in FIG. 14 includes a bias voltage generating unit 50, a voltage follower unit 60, a current balance unit 70, a variable-resistance element 42D, and transfer gates 81-84.

As bias voltage generating unit 50, voltage follower unit 60 and current balance unit 70 are equivalent to those of current-voltage converting circuit 4B shown in FIG. 9, description thereof is not repeated here.

Variable-resistance element 42D is connected between node N13 and node N17. It is assumed here that the resistance value of variable-resistance element 42D is Rd. Bias voltage BIAS is supplied to a node N15D and constant current I flows through variable-resistance element 42D.

Transfer gate 81 establishes/breaks connection between node N15D and node N13 according to control signals PLUS and /PLUS. Transfer gate 82 establishes/breaks connection between node N15D and node N17 according to control signals PLUS and /PLUS. Transfer gate 83 establishes/breaks connection between node N13 and node N18 according to control signals PLUS and /PLUS. Transfer gate 84 establishes/breaks connection between node N17 and node N18 according to control signals PLUS and /PLUS.

When control signal PLUS has an H or logical high level (control signal /PLUS has an L or logical low level), transfer gates 82 and 83 turn on to establish connections between nodes N15D and N17 and between nodes N13 and N18. At this time, current-voltage converting circuit 4D has its circuit configuration which is equivalent to that of current-voltage converting circuit 4C. Then, reference voltage VREFd of current-voltage converting circuit 4D supplied from node N18 is represented by:

VREFd=BIAS+I·Rd.

On the other hand, when control signal PLUS has L level (control signal /PLUS has H level), transfer gates 81 and 84 turn on to establish connections between nodes N15D and N13 and between nodes N17 and N18. At this time, current-voltage converting circuit 4D has its circuit configuration which is equivalent to that of current-voltage converting circuit 4C. Then, reference voltage VREFd of current-voltage converting circuit 4C that is obtained from node N18 is represented by:

VREFd=BIAS−I·Rd.

Bias voltage BIAS has no temperature dependency and variable-resistance element 42D having resistance value Rd has a small temperature coefficient compared with the positive and negative temperature coefficient described in FIGS. 2 and 3. Therefore, reference voltage VREFd of current-voltage converting circuit 4D has its temperature dependency which is substantially the same as that of constant current I, regardless of the states of control signals PLUS and /PLUS.

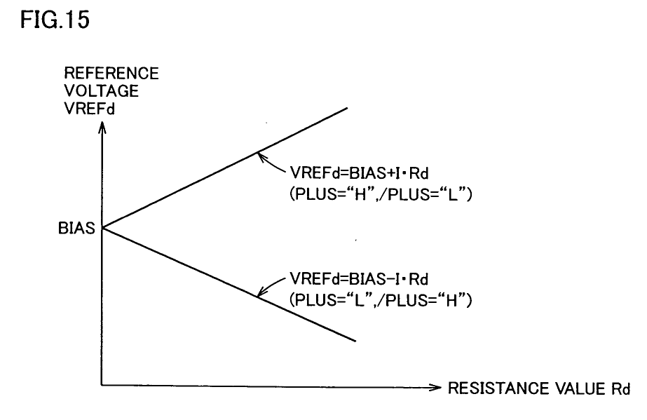

FIG. 15 shows a relation between reference voltage VREFd and resistance value Rd of current-voltage converting circuit 4D.

As shown in FIG. 15, reference voltage VREFd of current-voltage converting circuit 4D changes differently depending on the states of control signals PLUS and /PLUS.

When control signal PLUS has H level (control signal /PLUS has L level), reference voltage VREFd is equal to BIAS+I·Rd and thus increases in proportion to the increase of resistance value Rd of variable-resistance element 42D.

When control signal PLUS has L level (control signal /PLUS has H level), reference voltage VREFd is equal to BIAS−I·Rd and thus decreases in proportion to the increase of resistance value Rd of variable-resistance element 42D.

Reference voltage VREFd of current-voltage converting circuit 4D changes differently with respect to the increase of resistance value Rd of variable-resistance element 42D according to the states of control signals PLUS and /PLUS. Then, control of the states of control signals PLUS and /PLUS and trimming of resistance value Rd of variable-resistance element 42D can be combined to produce reference voltage VREFd within a wide voltage range that has its temperature dependency which can arbitrarily be set within a specific range.

As heretofore discussed, according to the second embodiment, the circuit configuration of current-voltage converting circuit 4 may be improved to produce a reference voltage within a wide voltage range that has its temperature dependency which can arbitrarily be set within a specific range.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A reference voltage generating circuit comprising:
a first constant current circuit having a positive temperature characteristic and outputting a first constant current;
a second constant current circuit having a negative temperature characteristic and outputting a second constant current;
a current synthesizing circuit synthesizing said first constant current and said second constant current to generate a third constant current, said first and second constant currents being synthesized at a ratio which allows a temperature characteristic of said third constant current to be within a range between said positive temperature characteristic and said negative temperature characteristic; and
a current-voltage converting circuit converting said third constant current into a voltage to generate a reference voltage.

2. The reference voltage generating circuit according to claim 1, wherein
said current synthesizing circuit includes
a first transistor connected with said first constant current circuit to form a current mirror and thereby generate a fourth constant current which is a product of said first constant current and a first factor,
a second transistor connected with said second constant current circuit to form a current mirror and thereby generate a fifth constant current which is a product of said second constant current and a second factor and
a third transistor receiving said third constant current to which said fourth constant current and said fifth constant current are added.

3. The reference voltage generating circuit according to claim 2, wherein
a ratio between the channel width and the channel length of said first and second transistors each can be changed.

4. The reference voltage generating circuit according to claim 1, wherein
said current-voltage converting circuit includes
a transistor connected with said current synthesizing circuit to form a current mirror and thereby receive said third constant current,
a variable-resistance element having a small temperature dependency compared with said positive and negative temperature characteristic and converting said third constant current into a first voltage, and
a reference voltage terminal outputting said first voltage as said reference voltage.

5. The reference voltage generating circuit according to claim 1, wherein
said current-voltage converting circuit includes
a bias voltage generating unit generating a bias voltage,
a variable-resistance element having a small temperature dependency compared with said positive and negative temperature characteristic and converting said third constant current into a first voltage, and
a reference voltage terminal outputting, as said reference voltage, a second voltage produced by adding said first voltage to said bias voltage.

6. The reference voltage generating circuit according to claim 1, wherein
said current-voltage converting circuit includes
a bias voltage generating unit generating a bias voltage,
a variable-resistance element having a small temperature dependency compared with said positive and negative temperature characteristic and converting said third constant current into a first voltage and
a reference voltage terminal outputting, as said reference voltage, a third voltage produced by subtracting said first voltage from said bias voltage.

7. The reference voltage generating circuit according to claim 1, wherein
said current-voltage converting circuit includes
a bias voltage generating unit generating a bias voltage,
a variable-resistance element having a small temperature dependency compared with said positive and negative temperature characteristic and converting said third constant current into a first voltage,
a selecting unit selecting, according to a control signal, one of a second voltage produced by adding said first voltage to said bias voltage and a third voltage produced by subtracting said first voltage from said bias voltage, and
a reference voltage terminal outputting, as said reference voltage, said second or third voltage selected by said selecting unit.
